(19) United States
(12) Patent Application Publication
(10) Pub. No.: US 2003/0214398 A1
(43) Pub. Date: Nov. 20, 2003

(54) Remote chemical monitoring system using satellite communication

(76) Inventors: Robert H. te Boekhorst, Guelph (CA); Radu Ilie, Kitchener (CA); Ian C. MacKellar, Brantford, CA (US)

Correspondence Address: BRINKS HOFER GILSON & LIONE, ONE INDIANA SQUARE, SUITE 1600, INDIANAPOLIS, IN, 46204-2033, US

(21) Appl. No.: 10/145,832

(22) Filed: May 14, 2002

(51) Int. Cl. G08B 1/00

(52) U.S. Cl. 340/531; 340/539.26

(57) ABSTRACT

A satellite and Internet based system for monitoring chemical processes uses a plurality of remotely located sensors coupled to a database server through a satellite communicator. The database server includes a data library adapted to hold chemical monitoring data from a plurality of remote chemical process sites. Information concerning the ongoing operation of the remote processes is posted to a secure Internet website by the database server. End-user defined trigger levels are used to examine the incoming process information. In the event of a trigger level being reached, a notification signal is generated and transmitted through one or more suitable channels outside the Internet to alert end-users of important changes in condition in the chemical process. The end-user can then access the secure website for further information and provide instructions to equipment at the remote chemical processing site via the internet and through the satellite communicator.

### FIELD OF THE INVENTION

The present invention relates generally to an information network, and more particularly to an Internet-accessible system for chemicals and process monitoring using a satellite communication and notification network.

### BACKGROUND OF THE INVENTION

Today's water industry faces increased regulation, public scrutiny, limited resources and rising costs. Monitoring the chemicals used to treat water is a crucial task for the safety of communities. One major concern in monitoring chemicals used in water treatment systems is that finding and notification of a problem condition can be limited to the station, which must relay the information to the appropriate response entity. This information relay can cost critical time better utilized in preventing further damage and remedying the situation.

There is a need in the art for a chemical process monitoring system that provides easy access from and to any remote area. The monitoring system must act as a notification network that provides the end-user with any critical information in a timely fashion.

There is a further need in the art for a threshold notification system operative so that when predefined conditions are met; an automatic notification is issued to the proper authority and/or user.

The Internet is a connection of multiple networks. The networks inter-operate over a suite of standardized protocols including TCP/IP, which sends data over the Internet in packets. Most information on the Internet is provided through a standardized navigation system called the worldwide web that links documents such as home pages on distant computers together. HTML is the standard format for providing information on the Internet. Access to the Internet has generally been through telephone lines, optical fiber cables and other connections to Internet service providers that are generally located in high population centers. Access to the Internet from remote areas has been more difficult to achieve, but access by way of cellular telephone and satellite-based communications systems is beginning to be incorporated.

Satellite monitoring of environmental conditions is well known as illustrated by U.S. Pat. No. 6,023,223 that uses low orbiting satellites that are positioned from 435 to 1000 miles above the earth. By using satellites in lower orbits, less powerful signals can be used to communicate with the satellites than with higher orbiting satellites. Low orbiting satellites are also less expensive to deploy, although a greater number can be required to cover the same area.

### SUMMARY OF THE INVENTION

This invention is directed to a novel Internet-based network of remotely located sensors that can transmit data to a transmission means including earth orbiting satellites. The present invention relates generally to an information network, and more particularly to an Internet-accessible system for remote chemical system and process monitoring using a satellite communication and notification network. Critical data from the system is stored in one or more database servers accessible through the Internet by standard protocols such as HTML and HTTP. The notification network provides the end-user with this critical information in a timely fashion.

A system in accordance with the present invention is especially well suited for small communities located in remote areas. The satellite monitoring system of the present invention allows for the monitoring of chemicals and chemical processes via the Internet. The system of the present invention combines a state-of-the-art knowledge system with reliable satellite communication and the internet to gain accurate and timely information regarding critical chemical conditions. A secure website is established prior to installation of the system that provides authorized personnel (such as water treatment personnel, regulatory technicians, engineers, officials or chemical suppliers) with critical information about the chemicals and processes involved. Installations in accordance with the present invention are ideally suited for portable totes and small tanks, particularly small above the ground tanks located in remote sites.

An alarm and notification system for monitoring chemicals and processes in accordance with the present invention generally includes a plurality of remotely located sensors having uplinks to a satellite communicator. A downlink interface is provided from the satellite communicator to a database server adapted to hold chemical monitoring data. A threshold notification means is provided between the database server and an end user interface for recording at least one end-user-defined trigger level for at least one condition so that a notification signal is generated and transmitted whenever at least one user-defined trigger level is changing the state. The notification signal can take the form of a satellite-based pager signal, cellular pager signal, email message, automated voice message, and/or automated fax transmission that is transmitted to one or more recipients.

Some of the features of a system in accordance with the present invention are the use of a satellite communicator that can achieve two-way communication with a chemical monitoring system, yet is simple to install and can require no governmental licensing. The system provides an interactive Internet data analysis and alarm broadcast system, which through low cost satellite communication, is especially useful in remote locations. The system can provide immediate notification of critical conditions by monitoring a plurality of digital and analog inputs and outputs of a chemical process. This immediate notification of critical conditions permits faster responsive actions and remediation procedures to take place.

Using the present invention, a wide variety of chemical data and/or maintenance information can be made available via a custom website eliminating the need to travel to the remote site. The system permits the control of chemicals without a trip to the remote site using operating commands such as start/stop, load/unload, or the like. Access to the information is achieved using a standard Internet browser so that no special hardware or software is required. Data compression can be employed that allows for accurate and affordable transfer of information. Summary reports can be prepared providing data analysis in a clear and concise format. When used with mobile units, an option for Global Positioning System (GPS) information can also be included. The system can use a variety of local power sources, and can include a back-up rechargeable battery in the event of power source failure.

The remote unit can be reconfigured with signals provided via the Internet. Options include adding or modifying the notification messages for each monitoring point, modifying digital alarm states, changing the identity or addresses of who is notified via satellite, alphanumeric or numeric pager, email, or other communication means. Each unit can support a plurality of notifications for each event. Alarm notification can be done using satellite pager anywhere in the world and does not require any local communication infrastructure.

These and other features and advantages of the present invention will become apparent from the following description of a preferred embodiment exemplifying the best mode of carrying out the invention. The following description has reference to the accompanying drawings.

### BRIEF DESCRIPTION OF THE DRAWINGS

FIG. 1 is a diagrammatic view of a preferred embodiment of the remote chemical monitoring system according to the invention.

FIG. 2 is a diagrammatic view of the notification system according to the invention.

### DESCRIPTION OF THE PREFERRED EMBODIMENT

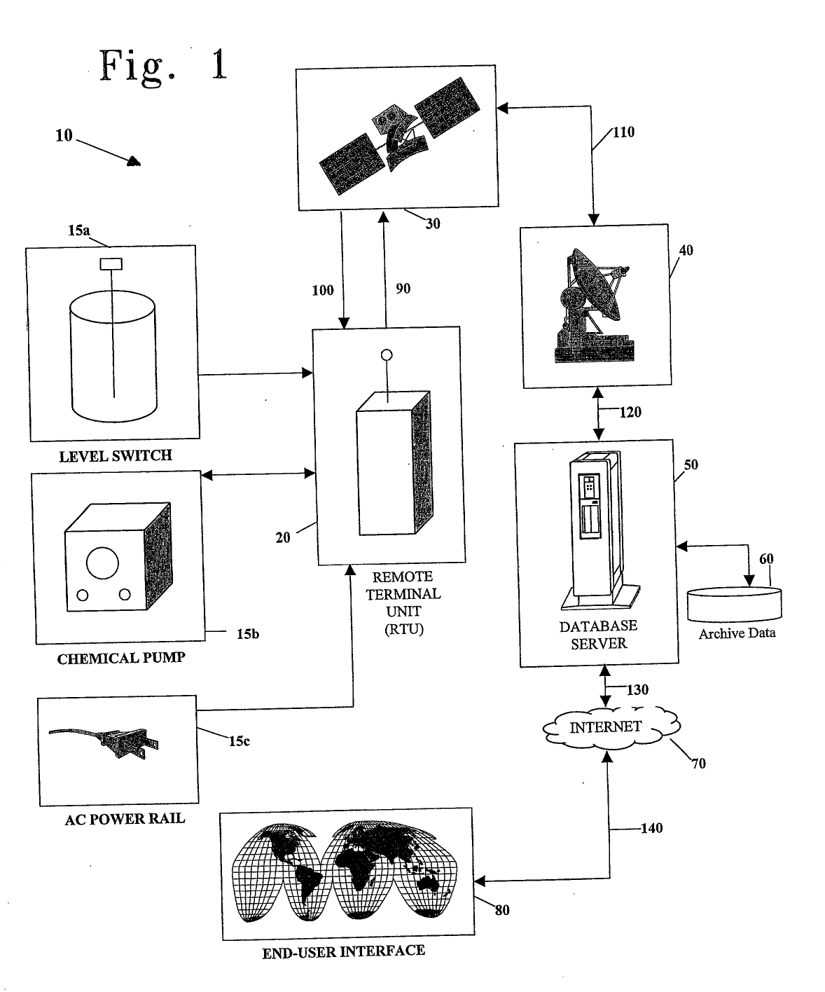

Referring initially to FIG. 1, it will there be seen that an illustrative embodiment of the present invention is denoted by the reference number 10 as a whole. A plurality of remotely located sensors 15a through 15c that monitor various chemical supply and process criteria are connected to a Remote Terminal Unit (“RTU”) 20. The RTU 20 periodically conducts a status check on the sensors 15a through 15c and sends data indicative of the sensor values through an uplink 90 to an orbiting satellite 30. A number of types of satellites can be utilized including low earth orbiting, geosynchronous, geostationary or any other suitable satellite capable of receiving transmissions from one or more RTUs. Additionally, other forms of wireless communication can be utilized to transmit the chemicals data including, but not limited to, analog cellular, digital cellular, global system for mobile communications, personal communications service and specialized mobile radio. The remotely located sensors for monitoring chemicals can include level switch 15a indicative of the quantity of chemical supplies held in reserve, chemical pump 15b indicative of the current state of operation and operational history of the chemical supply process, AC power rail 15c or the like indicative of the present ability to cause sufficient power to be supplied to the chemical pump 15b. The RTU 20 includes a communication interface for sending and receiving signals to/from satellite 30.

A satellite link 110 transmits the chemical system monitoring data collected from the RTU 20 to a ground receiving station 40. A downlink interface 120 sends the data to a database server 50. In a preferred embodiment, the downlink interface 120 utilizes a high-speed, dedicated data connection to the database server 50 by a T-1, T-3 or asynchronous transfer mode (“ATM”) connection. It is also preferred that database server 50 be mirrored by other servers on a global basis through a separate data connection to store the data in data archive 60 to reduce the likelihood of any loss of data. Mirroring of the main database server 50 also permits users in different geographic areas to access data through the shortest network connection.

A communication interface 130 between the database server 50 and the internet 70 provides end-user access through connection 140 to the data through a text or graphical end-user interface 80. The communication interface 130 preferably utilizes a web server supporting Boolean or search query language (“SQL”) capabilities. The results to the end-user interface 80 might be displayed in an HTML form or in a GIF or JPEG chart graphic generated on the database server 50 and posted to the end-user interface 80.

The communication interface 130 connects the database server 50 to the Internet 70. The communication interface 130 is preferably a high-bandwidth connection to provide an appropriate response rate. An end-user interface 80 connects to the Internet 70 through an end-user connection 140 which can comprise any TCP/IP compliant pathway.

The RTU 20 can be pre-configured to periodically upload diagnostic information through the communication uplink 90 to insure that the unit, monitoring sensors 15a-15c, is properly functioning. However, it also can be desirable to command a remotely located chemical system like chemical pump 15c into or out of operation. The information can sent from the database server 50 through link 110 to the satellite 30 and on to the RTU 20 through the communication downlink 100.

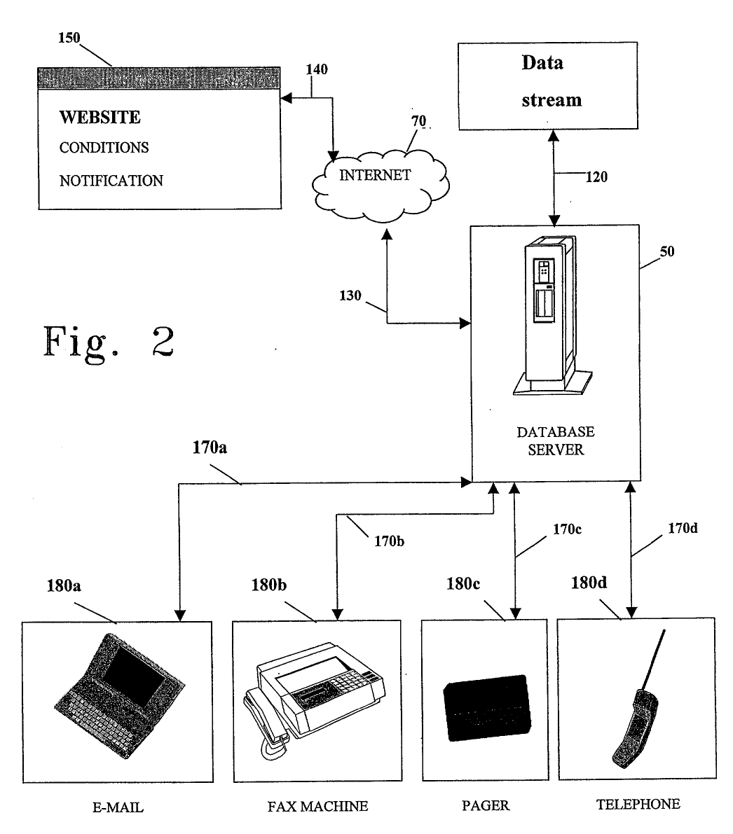

FIG. 2 illustrates a conditional threshold notification feature of the invention. A website trigger configuration interface 150 is provided to the end-user. The user can be identified by a login process comprising, for example, a user name and a password. Once the end-user is identified in the system, the end-user or associates can use the end user connection 140 to connect to database server 50 by way of the internet 70 and communications interface 130. Once connected to the database server 50, the end-user can select certain chemical system monitoring conditions or notifications. For example, a low level of chemical can alert the chemical supplier while a fault of the chemical pump can alert the end-user maintenance crew. The notification can include various delivery modes including, for example, e-mail 180a, fax communication 180b, numeric or alphanumeric cellular or satellite paging 180c, or automated voice response 180d. These selections are stored within database server 50. The database server 50 continually updates data from the satellite link interface 120. When a chemical condition meets the criteria preset by the end-user in website 150, a notification 170a-d is sent to the pre-selected communication devices 180a-d.

One benefit of a system according to the present invention is that multiple parties can be notified simultaneously when a trigger condition is met. Trigger conditions can also include threshold values that can be modified by suitably identified personnel. For example, a delay of momentary control contact time can be set to eliminate false signals. Other benefits of a system according to the present invention, including those made apparent from the foregoing description, are efficiently attained and since certain changes can be made in the above construction without departing from the scope of the invention.

What is claimed is:

1. An alarm and notification network for monitoring chemicals comprising:
a plurality of remotely located sensors having uplink to a satellite communicator;
a downlink interface from the satellite communicator to a database server adapted to hold chemical monitoring data;
a threshold notification means between the database server and an end user interface, the threshold notification means being adapted to record at least one end-user-defined trigger level for at least one condition whereby a notification signal is generated and transmitted when at least one user-defined trigger level is changing state.

2. The alarm and notification network of claim 1, wherein said notification signal comprises a pager message.

3. The alarm and notification network of claim 1, wherein said notification signal comprises an e-mail message.

4. The alarm and notification network of claim 1, wherein said notification signal comprises an automated voice message via telephone.

5. The alarm and notification network of claim 1, wherein said notification signal comprises an automated fax transmission.

6. The alarm and notification network of claim 1, wherein said notification signal is transmitted to a plurality of recipients.

7. An alarm and notification network for monitoring chemicals comprising:
a plurality of remotely located sensors, and a remote terminal unit coupled to the plurality of sensors, the remote terminal unit having a first satellite communicator;
a second satellite communicator coupled to a database server, the database server including a library of chemical monitoring data and a secure website connection to the internet;
a threshold notification means between the database server and an end user interface, the threshold notification means being adapted to record at least one end-user-defined trigger level for at least one condition whereby a notification signal is generated and transmitted when at least one user-defined trigger level is changing state.

8. The alarm and notification network of claim 1, further comprising at least one signal recipient coupled to the end user interface the signal recipient including an operating command signal generator for generating signals for transmission via the network to the remote terminal unit.

9. The alarm and notification network of claim 8, wherein the operating command signal generator further comprises an Internet connection to the secure website through the end-user interface for initiating commands to at least one remotely located terminal unit to control chemical use.

10. A method for monitoring chemical use at a remote site comprising the steps of:
sensing a plurality of conditions at a remote site where at least one chemical is used in a process and generating a first signal indicative of the sensed conditions,
sending the first signal via a satellite to a database server including a library of chemical monitoring data and a secure website connection to the internet;
comparing at the database server the sensed conditions as indicated by the first signal with certain end-user defined trigger levels for the sensors and generating a notification signal that is posted to the secure website in the event that any sensed condition reaches one of the defined trigger levels thereby causing a change in state, and
transmitting the notification signal via at least one additional communication means whenever at least one user-defined trigger level changes state.

11. The method of claim 10 further comprising the steps of:
remotely accessing the database server to provide an instruction that is encoded into a second signal and
sending the second signal via the satellite to the remote site so that the instruction can cause a change in said process.

12. The method of claim 10 further comprising the steps of:
associating at the database server the sensed conditions as indicated by the first signal with selected data from the library of chemical monitoring data, and
posting to a secure web site the results of the associating step for access by an end-user.

13. The method of claim 12 wherein said transmitting step is performed by directing the notification signal to a device in the possession of said end-user.

14. The method of claim 12 further comprising the step of mirroring the results of the associating step by at least one other server coupled to database server and to the Internet.

15. The method of claim 10 wherein the sensing step comprises periodically checking the status of a plurality of sensors monitoring chemical use in said process at the remote site.

16. The method of claim 10 wherein the monitoring step is performed at a plurality of remote sites, the generating step including the step of linking a location identification component to the plurality of conditions to form a first signal that is indicative of the sensed conditions at a specific site, and the comparing step includes the step of associating at the database server the sensed conditions as indicated by the first signal with selected data from the library of chemical monitoring data related to the specific site.

17. The method of claim 10 wherein the monitoring step includes the steps of quantifying the amount of chemical supplies available for the process, assessing the power supplies available to deliver the chemical supplies to the process, and checking the current operational state of delivery means for delivering the chemical supplies to the process.

18. A method for monitoring chemical use at a remote site comprising the steps of:
sensing a plurality of conditions at a remote site where at least one chemical is used in a process and generating a first signal indicative of the sensed conditions,
sending the first signal via a satellite to a database server including a library of chemical monitoring data and a secure website connection to the Internet;
associating at the database server the sensed conditions as indicated by the first signal with selected data from the library of chemical monitoring data, and
posting to a secure web site the results of the associating step for access by an end-user.

19. The method of claim 18 further comprising the steps of:
examining the results of the associating step for the presence of certain end-user defined trigger levels for the sensors,
generating a notification signal in the event that any sensed condition reaches one of the defined trigger levels thereby causing a change in state, and
transmitting the notification signal via at least one additional communication means whenever at least one user-defined trigger level changes state.

20. The method of claim 19 further comprising the steps of:
remotely accessing the database server to provide an instruction that is encoded into a second signal and
sending the second signal via the satellite to the remote site so that the instruction can cause a change in said process.

21. The method of claim 20 wherein
said sensing step is performed at a plurality of remote sites and the generating step includes the step of linking a location identification component to the plurality of conditions to form the first signal so that the first signal is indicative of the sensed conditions at a specific site,
said associating step includes the step of associating at the database server the sensed conditions as indicated by the first signal with selected data from the library of chemical monitoring data related to the specific site, and
said posting step is to a chemical process site specific web site.
